(19) United States
(12) Patent Application Publication
(10) Pub. No.: US 2008/0148779 A1
(43) Pub. Date: Jun. 26, 2008

(54) BACKUP STRUCTURE FOR HOLLOW TUBE MADE OF PLATINUM OR A PLATINUM ALLOY

(75) Inventors: Shinji TAKESHITA, Chiyoda-ku (JP); Kazuhiko Ishimura, Chiyoda-ku (JP); Sei Nagano, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 12/018,286

(22) Filed: Jan. 23, 2008

Related U.S. Application Data
(63) Continuation of application No. PCT/JP2006/311560, filed on Jun. 8, 2006.

(30) Foreign Application Priority Data
Jul. 26, 2005 (JP) 2005-215701

(51) Int. Cl. C03B 5/16; C03B 5/225; B32B 18/00

(52) U.S. Cl. 65/134.2; 428/34.4; 428/34.6; 65/374.13

(57) ABSTRACT

A backup structure for hollow tube made of platinum or a platinum alloy in which glass exudation from bricks employed for the backup is prevented, is provided and a vacuum degassing apparatus and a glass producing apparatus employing such a backup structure are provided.

A backup structure for hollow tube made of platinum or platinum alloy, which is used in a high-temperature environment, which contains a fused cast refractory layer provided along an outer surface of the hollow tube made of platinum or a platinum alloy, wherein at least in a portion of the fused cast refractory layer in contact with the outer surface of the hollow tube, the component ratio of fused cast refractories containing at most 10 mass % of matrix glass phase, is at least 50 vol %.

### TECHNICAL FIELD

The present invention relates to a backup structure (hereinafter it may be referred to as “backup structure of the present invention”) for a hollow tube made of platinum or a platinum alloy used in a high-temperature environment. The backup structure of the present invention is suitable for a backup structure for a hollow tube made of platinum or a platinum alloy to be used as a conduit tube of molten glass in a glass-producing apparatus, particularly, suitable for a backup structure of an uprising pipe and a downfalling pipe of a vacuum degassing apparatus of molten glass (hereinafter, it may be simply referred to as “vacuum degassing apparatus”).

Further, the present invention relates to a vacuum degassing apparatus for molten glass, a vacuum degassing apparatus and a glass producing apparatus employing such a backup structure.

### BACKGROUND ART

In a glass-producing apparatus such as a vacuum degassing apparatus, hollow tubes made of platinum or a platinum alloy such as a platinum-gold alloy or a platinum-rhodium alloy is used for conduit tubes of molten glass. However, since platinum and platinum alloys are expensive materials, the thickness of such a hollow tube is preferably as thin as possible. For this reason, it is common that a backup structure provided around a hollow tube made of platinum or a platinum alloy and such a backup structure mechanically supports the hollow tube.

Particularly, in cases of uprising pipe and downfalling pipe of a vacuum degassing apparatus in which molten glass flows upward and downward directions respectively, strong forces are applied to the inner surfaces of these pipes from the molten glass flowing through the inside of these pipes, and thus, presence of backup structures is particularly important.

FIG. 3 is a schematic view showing a general structure of a vacuum degassing apparatus. The vacuum degassing apparatus 100 shown in FIG. 3 is used for a process of vacuum-degassing a molten glass G in a melting vessel 200 and continuously supplying the molten glass G to the subsequent treatment vessel. In the vacuum degassing apparatus 100 shown in FIG. 3, a vacuum degassing vessel 102 having a cylindrical shape is accommodated in a vacuum housing 101 so that its long axis is oriented in a horizontal direction. To an underside of one end of the vacuum degassing vessel 102, an uprising pipe 103 oriented in a vertical direction is attached, and to an underside of the other end of the vacuum degassing vessel, a downfalling pipe 104 is attached. A part of each of the uprising pipe 103 and the downfalling pipe 104 is accommodated in the vacuum housing 101. In the vacuum housing 101, a heat insulation material 105 is disposed around the vacuum degassing vessel 102, the uprising pipe 103 and the downfalling pipe 104 so as to coat them for heat insulation.

Patent Document 1 discloses a backup structure of a conduit tube for high-temperature molten material such as an uprising pipe and a downfalling pipe of a vacuum degassing apparatus. In Patent Document 1, bricks for heat insulation are disposed around an uprising pipe and a downfalling pipe to constitute a backup structure. In Patent Document 1 (U.S. Pat. No. 5,851,258, paragraph 6, line 5), zirconia type fused cast refractories are described as an example of bricks for heat insulation since they have anticorrosive properties against molten glass.

Patent Document 1: JP-A-09-059028 (U.S. Pat. No. 5,851,258)

### DISCLOSURE OF THE INVENTION

### Problems to be Solved by the Invention

As a zirconia type fused cast refractory, an alumina-zirconia-silica (AZS) base fused cast refractory is the most widely used as a refractory material of glass kiln since the material is excellent in heat resistance and corrosion resistance against molten glass. Since an AZS base fused cast refractory is excellent in heat resistance and corrosion resistance against molten glass, such an AZS base fused cast refractory has been considered to be suitable for a backup structure for a hollow tube made of platinum or a platinum alloy constituting an uprising pipe or a downfalling pipe of a vacuum degassing apparatus.

However, when an AZS base fused cast refractory is heated to at least 1,450° C. in a normal pressure, a phenomenon called glass exudation that a matrix glass layer is pushed out of a brick occurs. In a glass kiln, there occurs a problem that an exudated glass react with a molten glass to produce a denaturated glass and such a denaturated glass is intermixed in the molten glass in some cases.

In the backup for the uprising pipe or the downfalling pipe, since molten glass flows through a hollow tube made of platinum or a platinum alloy constituting the uprising pipe or the downfalling pipe, the AZS type fused cast refractories do not directly contact with the molten glass. Accordingly, the possibility of occurring the above problem is considered to be low.

However, when exudation of glass occurs, it may adversely affect the uprising pipe, the downfalling pipe or the backup structure itself, and thus, it has been necessary to prevent occurrence of glass exudation. Particularly, in a case where AZS type fused cast refractories are used for the backup structure of the uprising pipe or the downfalling pipe, it is important to control the temperature of the vacuum degassing apparatus so that the fused cast refractories are not heated to higher than 1,450° C. for the purpose of preventing occurrence of glass exudation.

The present inventors have discovered that when AZS type fused cast refractories are used for a backup structure for a hollow tube made of platinum or a platinum alloy constituting an uprising pipe or a downfalling pipe of a vacuum degassing apparatus, glass exudation occurs even at a temperature lower than 1,450° C. such as a temperature between 1,200 to 1,450° C. in some cases.

The reason why glass exudation occurs at a temperature lower than 1,450° C. when AZS type fused cast refractories are used for a backup structure for a hollow tube made of platinum or a platinum alloy constituting an uprising pipe or a downfalling pipe, is not clear, but it is considered that since the backup structure is disposed in a vacuum housing in the vacuum degassing apparatus, the AZS type fused cast refractories are placed in a vacuum atmosphere, and this arrangement is considered to influence the occurrence of glass exudation.

When glass exudation occurs, a matrix glass phase is retained between the fused cast refractories and a hollow tube made of platinum or a platinum alloy constituting an uprising pipe or a downfalling pipe. On the external surface of the uprising pipe or the downfalling pipe, a force pushing inwardly is applied by the glass base matrix retained. However, when the vacuum degassing apparatus is used, on the inner surface of the hollow tube made of platinum or a platinum alloy constituting an uprising pipe or a downfalling pipe, a force pushing outwardly is applied by molten glass flowing through the tube, and thus, it is not likely that the retention of matrix glass phase causes a problem.

When molten glass is removed from the uprising pipe or the downfalling pipe after operation of the vacuum degassing apparatus is finished, a problem is caused by the retained matrix glass phase. When the molten glass is removed from the uprising pipe or the downfalling pipe, a force pushing an inner face of the hollow tube made of platinum or a platinum alloy constituting the uprising pipe or the downfalling pipe, disappears. As a result, the outer face of the uprising pipe or the downfalling pipe is pushed inwardly by the retained matrix glass phase, whereby the surface of the pipe is deformed and the pipe is squashed in the worst case. Further, glass once exudated does not move back into bricks but remains exudated even if the temperature is lowered, and once exudation occurs, it is extremely difficult to repair deformation of the wall of the pipe.

When the deformation of pipe wall is significant, it becomes necessary to replace the hollow tube made of platinum or a platinum alloy constituting an uprising pipe or a downfalling pipe. Further, even in a case where deformation of pipe wall is not so significant as to require replacement of the pipe, mechanical strength of the pipe is considered to be deteriorated as compared with that before deformation, and such a deterioration may cause destruction of the hollow tube made of platinum or a platinum alloy constituting an uprising pipe or a downfalling pipe.

The present invention has been made to solve the above-mentioned problems, and it is an object of the present invention to provide a backup structure for a hollow tube made of platinum or a platinum alloy in which occurrence of glass exudation from bricks to be used for backing up the hollow tube, and to provide a vacuum degassing apparatus, a vacuum degassing method and a glass-producing apparatus employing such a backup structure.

### Means of Solving the Problems

In order to achieve the above objects, the present invention provides a backup structure for hollow tube made of platinum or platinum alloy, which is used in a high-temperature environment, which contains a fused cast refractory layer provided along an outer surface of the hollow tube made of platinum or a platinum alloy, wherein in the fused cast refractory layer, the component ratio of fused cast refractories containing at most 10 mass % of matrix glass phase is at least 50 vol %.

It is preferred that in the fused cast refractory layer, the component ratio of fused cast refractories containing at most 10 mass % of matrix glass phase is at least 80 vol %.

In the backup structure of the present invention, it is preferred that in the fused cast refractories containing at most 10 mass % of matrix glass phase, the content of metal oxides existing as inevitable impurities is less than 2 mass %.

It is preferred that the fused cast refractories containing at most 10 mass % of matrix glass phase are alumina base fused cast refractories or high-zirconia base fused cast refractories.

In the backup structure of the present invention, it is preferred that a refractory heat insulating material is provided on the outside of the fused cast refractory layer.

Further, the present invention provides a vacuum degassing apparatus for molten glass having an uprising pipe, a vacuum degassing vessel and a downfalling pipe, which has the backup structure as defined in any one of Claims 1 to 12 for backing up at least one of the uprising pipe and the downfalling pipe.

Further, the present invention provides a glass-producing apparatus employing the backup structure of the present invention for backing up a conduit tube for molten glass.

Further, the present invention provides a method for vacuum-degassing molten glass by using a vacuum-degassing apparatus having an uprising pipe, a vacuum-degassing vessel and a downfalling pipe, wherein the backup structure as defined in any one of Claims 1 to 12 is used for backing up at least one of the uprising pipe and the downfalling pipe.

### EFFECTS OF THE INVENTION

In the backup structure of the present invention, the component ratio of fused cast refractories containing at most 10 mass % of matrix glass phase, in a fused cast refractory layer provided along an outer surface of a hollow tube, is at least 50 vol %. When the backup structure is used for backing up a hollow tube made of platinum or a platinum alloy to be used in a high-temperature environment, the amount of glass exudation from the fused cast refractory layer is extremely small. For this reason, there is no possibility that an outer surface of the hollow tube made of platinum or a platinum alloy is pushed inwardly by the exudated matrix glass phase to be deformed. Accordingly, by employing the backup structure of the present invention, it is possible to use the hollow tube made of expensive platinum or a platinum alloy for a long time.

When AZS type fused cast refractories containing large percentage of matrix glass phase are employed for backing up an uprising pipe or a downfalling pipe of a vacuum degassing apparatus, there is a possibility that the outer surface of the hollow tube made of platinum or a platinum alloy constituting an uprising pipe or a downfalling pipe is pushed inwardly by exudated matrix glass phase to be deformed even at a temperature between 1,200 to 1,450° C. When the heating temperature of the fused cast refractory layer at a time of using the vacuum degassing apparatus is set to 1,200° C. or about 1,000° C. or lower, prevention of glass exudation is considered to be possible. However, making the heating temperature of the fused cast refractory layer provided along the outer surface of the hollow tube made of platinum or a platinum alloy constituting an uprising pipe or a downfalling pipe to be 1,200° C. or lower than 1,000° C., is not practical for the purpose of exhibiting vacuum degassing performance.

When the backup structure of the present invention is employed for backing up an uprising pipe or a downfalling pipe of a vacuum degassing apparatus, even if the heating temperature of the fused cast refractory layer provided along the outer surface of the uprising pipe or the downfalling pipe is from 1,000 to 1,450° C., or even if the temperature is at least 1,450° C., there is no possibility that the outer surface of the hollow tube made of platinum or a platinum alloy constituting the uprising pipe or the downfalling pipe, is pushed inwardly by the exudated matrix glass phase to be deformed. For this reason, there is no possibility that the heating temperature of the vacuum degassing apparatus is not restricted by the fused cast refractory layer provided along the outer surface of the hollow tube made of platinum or a platinum alloy constituting the uprising pipe or the downfalling pipe.

In the glass-producing apparatus of the present invention, since the backup structure of the present invention is used for backing up a conduit tube for molten glass, even in a case where the vacuum is turned off and the molten glass is removed from the glass-producing apparatus in such a case as a trouble, it is not necessary to replace the conduit tube for molten glass. Accordingly, it is possible to use the conduit tube for molten glass for a long time. Accordingly, productivity of glass is improved by employing the glass-producing apparatus of the present invention. Further, the production cost of glass is cut down.

In the vacuum degassing apparatus of the present invention, since the backup structure of the present invention is employed for backing up a hollow tube made of platinum or a platinum alloy constituting an uprising pipe or a downfalling pipe, there is no possibility that the temperature of the vacuum degassing apparatus is not restricted by the fused cast refractory layer provided along the outer surface of the uprising pipe or the downfalling pipe. Accordingly, it is possible to make the temperature of the vacuum degassing apparatus to an optimum temperature for e.g. degassing characteristics or fluidity characteristics of molten glass.

Further, in a case of starting flowing of molten glass after the vacuum degassing apparatus is built up, the flow of molten glass is usually started after the vacuum degassing apparatus is heated in advance. In this case, the preheating is carried out to a temperature higher than the temperature of normal operation in most cases. In the vacuum degassing apparatus of the present invention, even if the apparatus is heated to such a high temperature, no exudation of matrix glass phase from the backup structure occurs, and thus, sufficient heating becomes possible.

### BRIEF DESCRIPTION OF THE DRAWINGS

FIG. 1 is a cross-sectional view of a vacuum degassing apparatus employing the backup structure of the present invention.

FIG. 2 is a partial enlarged view showing an uprising pipe 103 and a backup structure 1 of the vacuum degassing apparatus 100 of FIG. 1.

FIG. 3 is a cross-sectional view showing a common structure of a vacuum degassing apparatus.

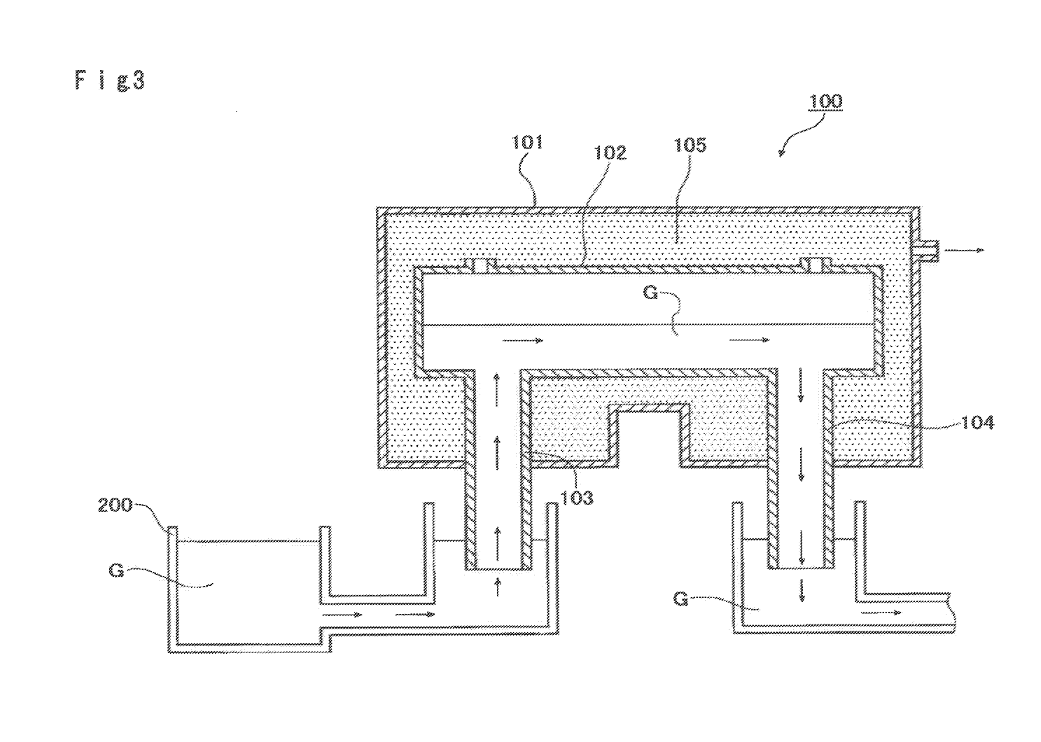

### BRIEF EXPLANATION OF NUMERALS

1: Backup structure
11: Fused cast refractory layer
11a: Fused cast refractory
12: Refractory brick layer
12a: Refractory brick
13: Irregular-shaped refractory
100: Vacuum degassing apparatus
101: Vacuum housing
102: Vacuum degassing vessel
103: Uprising pipe
104: Downfalling pipe
105: Heat insulating member
106: Flange
200: Melting vessel

### BEST MODE FOR CARRYING OUT THE INVENTION

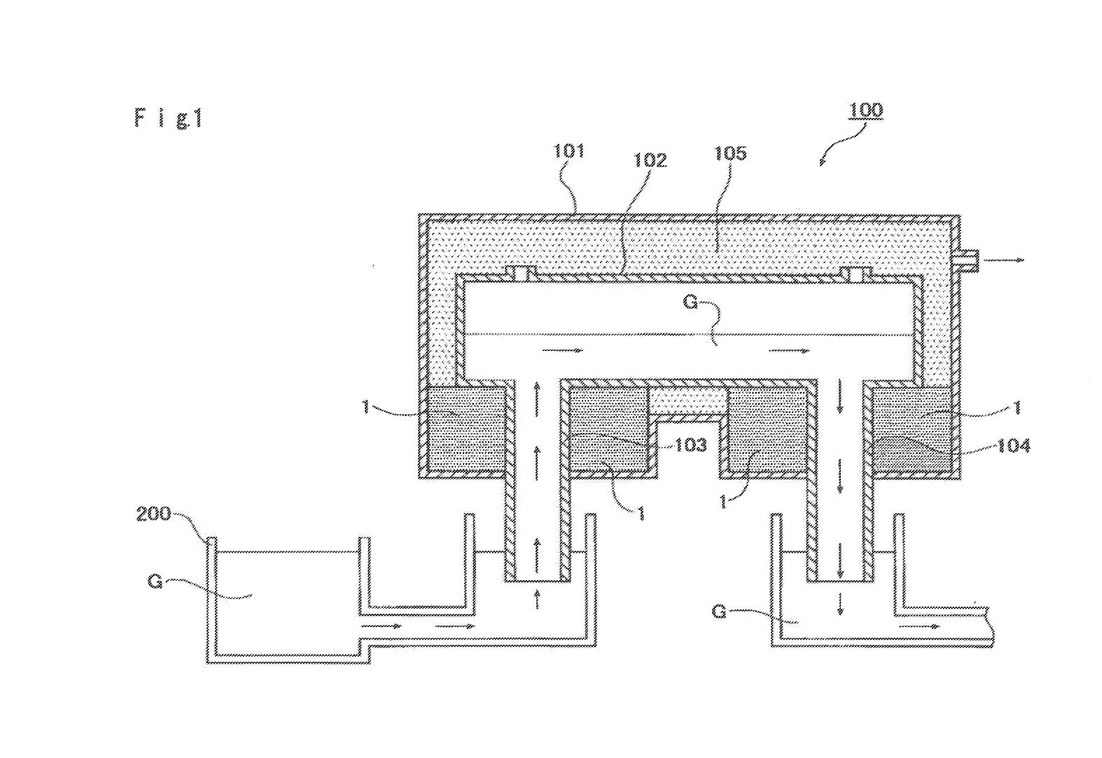

Now, the present invention will be described with reference to drawings. FIG. 1 is a cross-sectional view of a vacuum degassing apparatus employing a backup structure of the present invention. A vacuum degassing apparatus 100 shown in FIG. 1 is to be used for a process of vacuum-degassing molten glass G in a melting vessel 200 and continuously supplying it to a subsequent process vessel.

The vacuum degassing apparatus 100 has a vacuum housing 101 inside of which is maintained to a vacuum state when the apparatus is used. In the vacuum housing 101, a vacuum degassing vessel 102 having a cylindrical shape is disposed so that its long axis is oriented in a horizontal direction. In the vicinities of side ends of the lower surface of the vacuum degassing apparatus 102, an uprising pipe 103 and a downfalling pipe 104 are attached, which are each oriented in a vertical direction. The uprising pipe 103 and the downfalling pipe 104 are each disposed so that a part of which is accommodated in the vacuum housing 101.

Around each of the uprising pipe 103 and the downfalling pipe 104 in the vacuum housing 101, a backup structure 1 of the present invention is disposed. Around the vacuum degassing vessel 102 in the vacuum housing 101, a heat insulating member 105 is provided.

In the vacuum degassing apparatus 100 shown in FIG. 1, the vacuum degassing vessel 102, the uprising pipe 103 and the downfalling pipe 104 are each a hollow tube made of platinum or a platinum alloy. Specific examples of platinum alloy includes a platinum-gold alloy and a platinum-rhodium alloy. A phrase “platinum or a platinum alloy” includes a reinforced platinum formed by dispersing a metal oxide in platinum or a platinum alloy. As the metal oxide to be dispersed, an oxide of a metal of Group 3, 4 or 13 of the Periodic Table such as Al₂O₃, ZrO₂ or Y₂O₃, is mentioned.

In the vacuum degassing apparatus 100 shown in FIG. 1, the vacuum degassing vessel 102 may be made of a ceramics type non-metallic inorganic material, namely, a dense refractory. As a specific example of the dense refractory, a fused cast refractory such as an alumina type fused cast refractory, a zirconia type fused cast refractory or an alumina-zirconia-silica type fused cast refractory, or a dense fired refractory such as a dense alumina type refractory, a dense zirconia-silica type refractory or a dense alumina-zirconia-silica type refractory may, for example, be mentioned. Further, the vacuum degassing vessel 102 may be one formed by lining a ceramics type non-metallic inorganic material with a platinum type material.

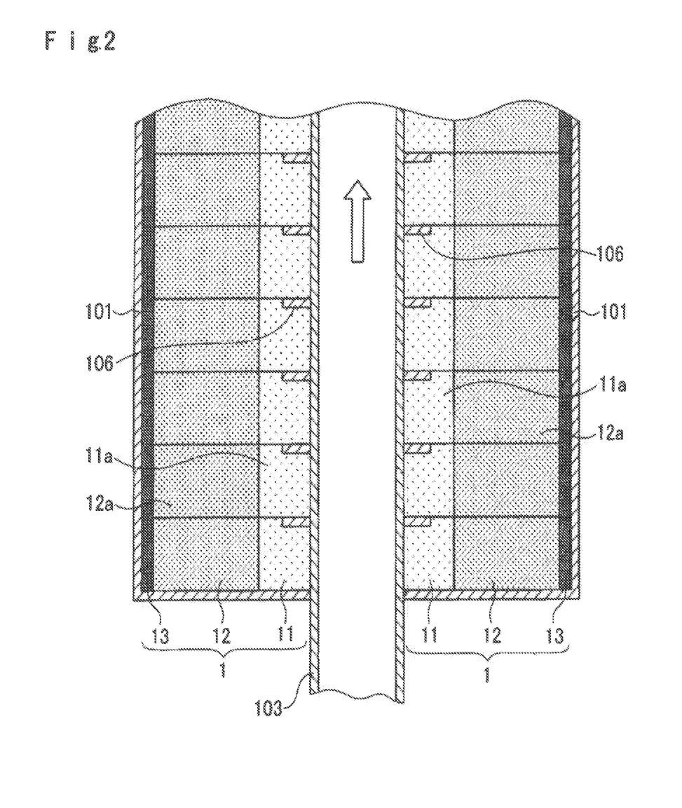

FIG. 2 is a partial enlarged view showing the uprising pipe 103 and the backup structure 1 of the vacuum degassing apparatus 100 of FIG. 1. In the following, explanation is made to the backup structure 1 of the uprising pipe 103, but a backup structure 1 of the downfalling pipe 104 has the same construction.

In FIG. 2, a fused cast refractory layer 101 is provided along the outer surface of the uprising pipe 103. The fused cast refractory layer 11 is constituted by fused cast refractories 11a, and is specifically formed by piling up the fused cast refractories 11a along the longitudinal direction of the uprising pipe 103.

Outside the fused cast refractory layer 11, a refractory brick layer 12 is provided. The refractory brick layer 12 is formed by piling up refractory bricks 12a along the longitudinal direction of the uprising pipe 103. In this specification, “a refractory brick” means a brick commonly categorized as a refractory brick other than a fused cast refractory, namely, it means a fired brick.

A gap between the refractory brick layer 12 and the vacuum housing 101 is filled with an irregular-shaped refractory 13. Namely, in the case of backup structure 1 shown in FIG. 2, the fused cast refractory layer 11 and a refractory heat-insulating member disposed outside the fused cast refractory layer constitute the backup structure 1, and the refractory heat-insulating member is constituted by the refractory brick layer 12 and the irregular-shaped refractory 13.

In the following, each constituent of the backup structure 1 is described in more detail.

The fused cast refractories 11a constituting the fused cast refractory layer 11 each has a dense fabric having low porosity, and the phase of the brick constitutes a stable crystal framework. These characteristics provides the fused cast refractories 11a with excellent heat resistance, corrosion resistance against molten glass and pollution resistance against glass basis material. Accordingly, such a fused cast refractory is suitable as a material of a layer provided along the outer surface of the uprising pipe 103.

The backup structure 1 of the present invention is characterized in that it employs fused cast refractories containing at most 10 mass % of matrix glass phase (hereinafter it is referred to as “low matrix glass phase fused cast refractory”) as the fused cast refractories 11a constituting the fused cast refractory layer 11. Here, it is not necessary that all of the fused cast refractories 11a constituting the fused cast refractory layer 11 are low matrix glass phase fused cast refractories, but it is sufficient that the composition ratio of low matrix phase fused cast refractories is at least 50 vol % at least in a portion of the fused cast refractory layer 11 in contact with the outer surface of the hollow tube, namely, in fused cast refractories disposed so as to be contact with the outer surface of the hollow tube. The composition ratio in this specification means the composition ratio of the low matrix glass phase fused cast refractories in all bricks disposed along the outer surface of the hollow tube so as to contact with the outer surface. Accordingly, in the fused cast refractory layer 11, a part of bricks in contact with the outer surface of the hollow tube may be fused cast refractories other than the low matrix glass phase fused cast refractories.

Here, the ratio of the matrix glass phase can be obtained by measuring the area of glass phase by an image analysis, or by analyzing the constituents of the glass phase (SEM-EDX) and comparing it with analyzed data of entire brick material.

As a material constituting a layer (a layer corresponding to a fused cast refractory layer 11 of FIG. 2) provided along the outer surface of an uprising pipe or a downfalling pipe of a vacuum degassing apparatus, AZS type fused cast refractories have been widely used heretofore. However, since such AZS type fused cast refractories contain, for example, 15 to 21 mass % of matrix glass phase, there is a possibility that when the bricks are heated to at least 1,450° C., exudated matrix glass phase pushes an outer surface of such a hollow tube inwardly to deform the tube wall.

Further, in a case where AZS type fused cast refractories are used as a material constituting a layer provided along the outer surface of an uprising pipe or a downfalling pipe of a vacuum degassing apparatus, even when the temperature of the fused cast refractories is at most 1,450° C., specifically, at a temperature between 1,000° C. to 1,450° C., particularly between 1,200° C. to 1,450° C., there is a possibility that exudated matrix glass phase pushes the outer surface of such a hollow tube inwardly to deform the tube wall.

In the present invention, since the component ratio of low matrix glass phase fused cast refractories in the fused cast refractory layer 11 is at least 50 vol %, even in a case of heating the layer to at least 1,450° C., glass exudation is extremely little. For this reason, there is no possibility that exudated matrix glass phase pushes the outer surface of hollow tube inwardly to deform the tube wall.

Further, when the fused cast refractory layer 11 is employed for backing up an uprising pipe or a downfalling pipe of a vacuum degassing apparatus and the fused cast refractory layer 11 is heated to a temperature between 1,000° C. to 1,450° C., particularly between 1,200° C. to 1,450° C., the amount of glass exudation is extremely small. For this reason, there is no possibility that exudated matrix glass phase pushes an outer surface of such a hollow tube inwardly to deform the tube wall.

To exhibit the above effect, the composition ratio of low matrix glass phase fused cast refractories in the fused cast refractory layer 11 is preferably high. The composition ratio of low matrix glass phase fused cast refractories in the fused cast refractory layer 11 is preferably at least 80 vol %, and it is particularly preferred that all of the fused cast refractory layer 11 is constituted by low matrix glass phase fused cast refractories.

For the same reason, the matrix glass phase fused cast refractories contain little matrix glass phase. In such a low matrix glass phase fused cast refractory, the content of matrix glass phase is preferably at most 5 mass %, more preferably at most 3 mass %. It is more preferred that such a low matrix glass phase fused cast refractory contains substantially no matrix glass phase.

It is preferred that the content of metal oxides present as unavoidable impurities in the low matrix glass phase fused cast refractory is less than 2 mass %.

An fused cast refractory contains metal oxides such as Fe₂O₃, CuO, PbO or Bi₂O₃ as unavoidable impurities. These metal oxides are easily reduced in a high-temperature environment.

The fused cast refractory layer 11 is heated to a high temperature when the vacuum degassing apparatus 100 is used. In the case of backup structure 1 of FIG. 1, the fused cast refractory layer 11 is heated to a temperature between 1,000° C. to 1,450° C., particularly between 1,200° C. to 1,450° C.

At the interface between the uprising pipe 103 and fused cast refractories 11a constituting the fused cast refractory layer 11, these metal oxides contained as unavoidable impurities may be reduced to form an intermetallic alloy of low melting point with the platinum material (platinum or a platinum alloy) constituting the uprising pipe 103. Forming of such an intermetallic alloy of low melting point may adversely affect characteristics of platinum or a platinum alloy constituting the uprising pipe 103. Namely, when the fused cast refractories 11a contain a large amount of metal oxides such as Fe₂O₃, CuO, PbO or Bi₂O₃, forming of such an intermetallic alloy of low melting point causes to lower the melting point of platinum material constituting the uprising pipe 103. As a result, there is a case where the uprising pipe 103 is melted even if the uprising pipe is heated to a temperature considered to be safe in its design.

In the case of backup structure 1 of the present invention, since the composition ratio of low matrix glass phase fused cast refractories in the fused cast refractory layer 11 is at least 50 vol %, presence of these metal oxides in the low matrix glass fused cast refractories is particularly critical. In a case of using low matrix glass phase fused cast refractories containing less than 2 mass % of metal oxides present as impurities, there is little possibility that intermetallic alloy of low melting point is formed, and further, influence on the melting point of platinum material constituting the uprising pipe 103 is negligible even if such an intermetallic alloy of low melting point is formed. It is preferred that in low matrix glass phase fused cast refractories, the content of metal oxides present as unavoidable impurities is less than 1 mass %, more preferably it is less than 0.05 mass %. It is particularly preferred that such low matrix glass phase fused cast refractories contains substantially no metal oxide such as Fe₂O₃, CuO, PbO or Bi₂O₃.

When the fused cast refractory layer 11 contains fused cast refractories (hereinafter referred to as “other fused cast refractories”) other than low matrix glass phase fused cast refractories, it is preferred that the content of metal oxides present as unavoidable impurities in such other fused cast refractories is preferably less than 2 mass %, more preferably less than 1 mass %, particularly preferably less than 0.05 mass %. It is particularly preferred that such other fused cast refractories contain substantially no metal oxides such as Fe₂O₃, CuO, PbO or Bi₂O₃.

Specific examples of fused cast refractories suitable for low matrix glass phase fused cast refractories, include alumina type fused cast refractories such as α-alumina type fused cast refractories, α,β-alumina type fused cast refractories and β-alumina type fused cast refractories, and high-zirconia type fused cast refractories. These fused cast refractories contain at most 10 mass % of matrix glass phase, and contains less than 2 mass % of metal oxides present as an unavoidable impurities. An alumina type fused cast refractory means a fused cast refractory containing at least 80 mass % in total of α-alumina and β-alumina, and is categorized into α-alumina type fused cast refractory, α,β-alumina type fused cast refractory and β-alumina type fused cast refractory according to the ratio between α-alumina and β-alumina contained in the fused cast refractory. A high-zirconia type fused cast refractory is a fused cast refractory containing at least 50 mass % of zirconia (ZrO₂).

Among these, alumina type fused cast refractories are preferred since they contain less matrix glass phase. Alumina type fused cast refractories such as α-alumina type fused cast refractories, α,β-alumina type fused cast refractories or β-alumina type fused cast refractories, each contain less than 2 mass % of matrix glass phase. Specific examples of alumina type fused cast refractories include Marsnite™ A (manufactured by Asahi Glass Company, Limited) and Monoflux A (manufactured by Toshiba Monoflux K.K. (currently Saint-Goban™ K.K.)) as α-alumina type fused cast refractories, Marsnite™ G (manufactured by Asahi Glass Company, Limited), Monoflux M (manufactured by Toshiba Monoflux K.K. (currently Saint-Goban™ K.K.)) and JAGUAR M (manufactured by Societe Europeenne Des Produits Refractaires) as α,β-alumina type fused cast refractories, and Marsnite™ U (manufactured by Asahi Glass Company, Limited), Monoflux H (manufactured by Toshiba Monoflux K.K. (currently Saint-Goban™ K.K.)) and JAGUAR H (manufactured by Societe Europeenne Des Produits Refractaires) as β-alumina type fused cast refractories. Here, as a high-zirconia type fused cast refractory, X-950 (manufactured by Asahi Glass Company, Limited) is mentioned.

In the backup structure of the present invention, it is essential that in a fused cast refractory layer 11 provided along an outer surface of a hollow tube made of platinum or a platinum alloy, the composition ratio of low matrix glass phase fused cast refractories is at least 50 vol %, and other constructional features are not particularly limited. Accordingly, other constructional features in the backup structure 1 of FIG. 2, namely, the refractory brick layer 12 provided outside the fused cast refractory layer 11 and the irregular-shaped refractory 13 filling a gap between the refractory brick layer 12 and the vacuum housing 101, have optional constructions. Accordingly, the backup structure of the present invention may be such that it only has a fused cast refractory layer provided along an outer surface of a hollow tube made of platinum or a platinum alloy.

However, the backup structure constituted only by the fused cast refractory layer is not preferred from the viewpoints of cost and heat-insulation effect. In the backup structure 1 shown in FIG. 2, the reason why the fused cast refractory layer 11 is provided along the outer surface of the uprising pipe 103, is because such a member is disposed at a position closest to the uprising pipe 103 and is required to have excellent heat resistance, and because such a member is required to have excellent corrosion resistance against molten glass so as not to be corroded when molten glass is leaked from the uprising pipe 103 into the member. Accordingly, among constituents of the backup structure 1, a layer provided at a position apart from the uprising pipe 103, may be made of fired bricks having lower heat resistance and lower corrosion resistance against molten glass than the fused cast refractories 11a.

The fused cast refractories are more expensive than the fired bricks, and thus, if the backup structure is constituted only by fused cast refractories, the cost becomes extremely high.

Further, in FIG. 1, the purpose of providing the heat-insulating member 105 around the vacuum degassing vessel 102 in the vacuum housing 101 is to keep warm the vacuum degassing vessel 102 in which molten glass flows through, by the heat insulation. Accordingly, the backup structure 1 for the uprising pipe 103 is also required to have a function of keeping the uprising pipe 103 warm by heat insulation. However, the fused cast refractories 11a having low porosity and dense fabric, are inferior to fired bricks having high porosity, in heat-insulation keep-warm capability. Accordingly, a backup structure 1 constituted only by fused cast refractories 11a, is not preferred for the purpose of keeping the uprising pipe 103 warm by heat insulation. For example, when a backup structure is constituted only by fused cast refractories having inferior heat-insulation keep-warm capability, since they radiate a large amount of heat, the backup structure needs to be extremely large.

For the reasons described above, the backup structure of the present invention preferably has a construction as shown in FIG. 2 that a fused cast refractory layer 11 is provided along the outer surface of a hollow tube (uprising pipe 103) made of platinum or a platinum alloy, and that outside the fused cast refractory layer 11, a refractory heat-insulating member (refractory brick layer 12 and irregular-shaped refractory 13) having more excellent heat-insulation efficiency than that of fused cast refractories, are provided. In the backup structure 1 shown in FIG. 2, around the fused cast refractory layer 11 having inferior heat-insulation keep-warm capability, a refractory brick layer 12 is provided to increase heat-insulation keep-warm capability. Further, by filling a gap between the refractory brick layer and a vacuum housing 101 with an irregular-shaped refractory 13 to further increase heat-insulation keep-warm capability.

Further, by using refractory bricks 12a that are less expensive than fused cast refractories 11a as refractory heat-insulation material provided at a position more distant from the uprising pipe 103, it is possible to reduce the cost required for the backup structure 1.

In the backup structure 1 show in FIG. 2, as the refractory heat-insulation member provided outside the fused cast refractory layer 11, a refractory brick layer 12 provided outside the fused cast layer 11, and an irregular-shaped refractory 13 filling a gap between a refractory brick layer 12 and a vacuum housing 101, are shown. However, the structure of the refractory heat-insulation member provided outside the fused cast refractory layer 11, is not limited to such a construction.

Here, it is preferred that molten glass leaked out from the uprising pipe 103 is stopped in the fused cast refractory layer 11 so that the molten glass does not reach the refractory brick layer 12 provided outside the fused cast refractory layer 11. For this purpose, it is preferred that surfaces of each fused cast refractory 11a in contact with adjacent fused cast refractories are finished by precision polishing so that those surfaces have little irregularities, to improve sealing capability. In the backup structure 1 of the present invention, it is preferred to set the positional range of the fused cast layer 11 so that even if molten glass is leaked out from the uprising pipe 103, the temperature of the molten glass is dropped to a temperature below its devitrification point during the molten glass passes through the fused cast refractory layer 11. Here, the devitrification point means a temperature at which the viscosity of glass becomes log η=5, which is usually about 1,000 to 1,100° C.

In the backup structure 1 shown in FIG. 2, one fused cast refractory 11a and one refractory brick 12a are piled up in the radial direction of the uprising pipe 103. However, this shows the positional relationship between the position where the fused brick 11a is provided and the position where the refractory brick 12a is provided, and the Figure is not intended to show that the numbers of fused cast refractories 1a and the refractory bricks 12a are always 1.

Generally speaking, in a backup structure for an uprising pipe or a downfalling pipe of a vacuum degassing apparatus, a plurality of heat-insulating members having the same or different compositions are employed, and they are disposed so that they form layers piled up in the radial direction of the uprising pipe or the downfalling pipe. In the backup structure of FIG. 2, a plurality of fused cast refractories 11a having the same or different compositions may be piled up in the radial direction of the uprising pipe 103 to form a fused cast refractory layer 11. The refractory brick layer 12 disposed outside the fused cast layer 11 may also have such a construction.

However, in the backup structure 1, the fused cast refractory layer 11 provided along the outer surface of the uprising pipe 103 and the refractory brick layer 12 provided outside the fused cast layer 11, are preferably constituted by a plurality of bricks (fused cast refractories 11a or refractory bricks 12a) having the same or different compositions piled up in the radial direction of the uprising pipe 103. When a single brick (fused cast refractory 11a or refractory brick 12a) is disposed for each of the fused cast layer 11a and the refractory brick layer 12, the thickness of the each of bricks in the radial direction of the uprising pipe 103 becomes extremely large. As a result, the temperature difference between an inner portion and an outer portion of each of the bricks becomes large, and the bricks may be destroyed.

In the backup structure 1 shown in FIG. 2, a plurality of fused cast refractories 11a and refractory bricks 12a are piled up in the longitudinal direction of the uprising pipe 103. By employing fused cast refractories 11a and refractory bricks 12a each having the height of the entire backup structure 1, it is possible to constitute the entire backup structure only by providing one each of the fused cast refractory 11a and the refractory brick 12a.

However, considering the difference of heat expansion coefficients among the uprising pipe 103 made of platinum or a platinum alloy, the fused cast refractories 11a and the refractory bricks 12a, the fused cast refractory layer 11 and the refractory brick layer 12 are preferably each constituted by piling up a plurality of fused cast refractories 11a or the refractory bricks 12a in the longitudinal direction of the uprising pipe 103 as shown in FIG. 2. When platinum or a platinum alloy constituting the uprising pipe 103 is compared with the fused cast refractories 11a, platinum or a platinum alloy has far higher heat expansion coefficient. For this reason, when the vacuum degassing apparatus 100 shown in FIG. 1 is used or is heated up, a large difference of heat expansion amounts occurs between the uprising pipe 103 and the fused cast refractories 11a, particularly in the longitudinal direction of the uprising pipe 103.

The backup structure shown in FIG. 2 has a function of dispersing heat expansion in the longitudinal direction of the uprising pipe 103 to ease the effect of the difference of heat expansions between the uprising pipe 103 and the fused cast refractories 11a.

In FIG. 2, disk-shaped flanges (projecting portions) 106 are provided on the outer periphery of the uprising pipe 103 with an interval in the longitudinal direction of the uprising pipe 103. Between fused cast refractories 11a piled up along the longitudinal direction of the uprising pipe 103, each of the flanges 106 of the uprising pipe 103 is sandwiched. Since heat expansion in the longitudinal direction of the uprising pipe 103 is distributed to portions between the flanges 106, influence of the difference of heat expansion amounts between the uprising pipe 103 and the fused cast refractories 11a is eased.

When the vacuum degassing apparatus 100 is used, the uprising pipe 103 shows heat expansion also in the radial direction. For this reason, the fused cast refractories 11a are disposed so as to have a predetermined gap from the uprising pipe 103 at a normal temperature. When the vacuum degassing apparatus 100 is used, the uprising pipe 103 thermally expands in the radial direction so that the outer surface of the uprising pipe 103 contact with the fused cast refractories 11a, whereby the backup structure 1 mechanically supports the uprising pipe 103.

In the backup structure of the present invention, the refractory bricks 12a constituting the refractory brick layer 12 are not particularly limited, and they can be selected from a wide range of fired bricks used for refractory members or backup structures.

As specific examples of fired bricks, high alumina bricks, clay type bricks or zirconia type bricks may, for example, be mentioned. As a high alumina brick, CWS, CWR, CWK or CWU (manufactured by Asahi Glass Company, Limited) or SP-13, 14 or 15 (manufactured by Hinomaru Ceramics Industries K.K.) may, for example, be mentioned. As a clay type brick, specifically, RG, CH or TB (manufactured by Asahi Glass Company, Limited) or NEOTEX-34 or 37 (manufactured by YOTAI REFRACTORIES CO., LTD.) may, for example, be mentioned. As a zirconia type brick, ZR or ZM (manufactured by Asahi Glass Company, Limited) may, for example, be mentioned.

In the backup structure 1 shown in FIG. 2, the irregular-shaped refractory 13 that may fill a gap between the refractory brick layer 12 and the vacuum housing 101, may be selected from a wide range of materials to be used for refractory members or backup structures. As irregular-shaped refractories to be used for these applications, castable refractories, plastic refractories or ramming materials are widely used. In the present invention, any one of these materials may be used, and may be selected according to properties required for the irregular-shaped refractory 13. For example, when the irregular-shaped refractory 13 is required to have a heat-insulation keep-warm property, a castable refractory, particularly, porous light-weight heat-insulating castable is preferred. On the other hand, when a filling property is required, a ramming material is preferred. In terms of workability, a plastic refractory is preferred. As a specific example of the irregular-shaped refractory 13, Microtherm (manufactured by Microtherm Corp.) may, for example, be mentioned.

In the backup structure 1 shown in FIG. 2, the irregular-shaped refractory 3 fills a gap between the refractory brick layer 12 and the vacuum housing 101, but use of the irregular shaped refractory 13 in the backup structure of the present invention is not limited to such a construction. For example, it may fill a gap between the fused cast refractory layer 11 and the refractory brick layer 12. Further, in a case where the fused cast refractories 11a constituting the fused cast refractory layer 11 or the refractory bricks 12a constituting the refractory brick layer 12, are composed of a plurality of bricks having the same or different compositions and piled up in the radial direction of the uprising pipe 103, the irregular-shaped refractory 13 may be disposed to fill a gap between these bricks.

In the vacuum degassing apparatus 100 shown in FIG. 1, when the vacuum degassing vessel 102 is a hollow tube made of platinum or a platinum alloy, the vacuum degassing vessel 102 is also provided with a backup structure. However, in the case of vacuum degassing vessel 102, since a force of molten glass flowing inside the vessel applied to the inner surface is weak as compared with that in the uprising pipe 103 or the downfalling pipe 104, there is less possibility that the wall of the vacuum degassing vessel 102 made of platinum or a platinum alloy is destroyed to cause leakage of molten glass to the outside. For this reason, bricks arranged along the outer surface of the vacuum degassing vessel 102 may be fired bricks having corrosion resistance inferior to that of fusion cast bricks.

The backup structure of the present invention has been described above using a backup structure for an uprising pipe or a downfalling pipe of a vacuum degassing apparatus as an example. However, the backup structure of the present invention is not limited to the backup structures for the uprising pipe and the downfalling pipe of the vacuum degassing apparatus, but it can be widely applied to backup structures for hollow tubes made of platinum or a platinum alloy to be used in a high-temperature environment. As a specific example of an application of the backup structure of the present invention, a backup structure of a conduit tube (a hollow tube made of platinum or a platinum alloy to be used for such a conduit tube) for molten glass in a glass-producing apparatus, may, for example, be mentioned. More specifically, a backup structure for a vacuum degassing vessel of a vacuum degassing apparatus, a flow out pipe provided for removing impurities from a glass-producing apparatus, a flow out tube for flowing molten glass out from a glass producing apparatus into a mold for forming the molten glass into optical components such as lenses or prisms, or a conduit tube from a melting vessel to a forming vessel, may be mentioned.

In the vacuum degassing method of molten glass of the present invention, uses a vacuum degassing apparatus employing the backup structure of the present invention for at least one or preferably both of an uprising pipe and a downfalling pipe, wherein molten glass supplied from a melting vessel is let pass through a vacuum degassing vessel inside of which is evacuated to a predetermined vacuum pressure, whereby the molten glass is vacuum-degassed. The molten glass is preferably continuously supplied to and discharged from the vacuum degassing vessel.

In order to prevent forming of a temperature difference between the vacuum degassing vessel and molten glass supplied from the melting vessel, the vacuum degassing vessel is heated so that the temperature inside of the vacuum degassing vessel is in a temperature range of from 1,100° C. to 1,500° C., particularly preferably from 1,250° C. to 1,450° C. Here, the flow rate of molten glass is preferably from 1 to 200 ton/day from the viewpoint of productivity.

When the vacuum degassing method is carried out, by evacuating the vacuum housing by e.g. a vacuum pump disposed outside, inside of the vacuum degassing vessel disposed in the vacuum housing is maintained to be in a predetermined vacuum state. Here, inside of the vacuum degassing vessel is preferably evacuated to from 30 to 460 mmHg (40 to 613 hPa), more preferably inside of the vacuum degassing vessel is evacuated to from 100 to 310 mmHg (133 to 413 hPa).

Glass to be vacuum degassed by the present invention is not limited in the composition so long as it is a glass produced by a heat-melting method. Accordingly, it may be an alkali glass such as a lime silica type glass or a borosilicate glass. However, non-alkali glass is suitable since bubbles in the glass are hard to be removed in its clearing step and it is employed in applications requiring defect-free property such as glass substrates for displays. Further, in the case of non-alkali glass, it is necessary to raise the temperature of the glass to a certain extent at the time of vacuum degassing, and considering this point, the present invention is further effective.

Dimensions of the vacuum degassing vessel may be appropriately selected according to a vacuum degassing apparatus to be applied regardless of whether the material of the vacuum degassing apparatus is a material of platinum type or a non-metallic inorganic material of ceramics type. In the case of vacuum degassing vessel 102 shown in FIG. 1, specific example of the dimensions are as follows.

Length in lateral direction: 1 to 20 m

Length of each side: 0.2 to 3 m (rectangular cross-section)

When the vacuum degassing vessel 102 is made of a material of platinum type, its wall thickness is preferably at most 4 mm, more preferably from 0.5 to 1.2 mm.

The vacuum housing 101 is made of e.g. a stainless steel, and has a shape and dimensions capable of accommodating a vacuum degassing vessel. The uprising pipe 103 and the downfalling pipe 104 are usually hollow tubes having circular cross-sections. The dimensions of the uprising pipe 103 and the downfalling pipe 104 may be appropriately selected according to a vacuum degassing apparatus to be applied. For example, the dimensions of the uprising pipe 103 and the downfalling pipe 104 may be as follows.

Inner diameter: 0.05 to 1 m, more preferably 0.1 to 0.6 m

(Dimension of each side in a case of hollow tube having a rectangular cross-section)

Length: 0.2 to 6 m, more preferably 0.4 to 4 m)

The wall thicknesses of the uprising pipe 103 and the downfalling pipe 104 are preferably from 0.4 to 5 mm, more preferably from 0.8 to 4 mm.

### EXAMPLES

Now, the present invention will be more specifically described with reference to Examples. However, the present invention is by no means limited to these Examples.

### EXAMPLE

In the Example, a vacuum degassing apparatus 100 shown in FIG. 1 is used to carry out vacuum degassing of molten glass. The molten glass is a non-alkali glass. In the vacuum degassing apparatus 100, backup structures of an uprising pipe 103 and a downfalling pipe 104 are each a backup structure 1 shown in FIG. 2. In the vacuum degassing apparatus 100, the materials of its components are as follows.

Vacuum housing 101: A stainless steel

Vacuum degassing vessel 102: A platinum-rhodium alloy (90 mass % of platinum and 10 mass % of rhodium)

Platinum tubes constituting uprising pipe 103 and downfalling pipe 104: A platinum-rhodium alloy (90 mass % of platinum and 10 mass % of rhodium)

The backup structure 1 is constituted by the following bricks in this order from the side of outer surface of each platinum tube.

The materials of the bricks and the way of disposition are as follows.

(1) Fused cast refractories 11a: α,β-alumina type fused cast refractories (Marsnite™ G (manufactured by Asahi Glass Company, Limited); content of matrix glass phase is 1 mass %) are employed. The fused cast refractories are disposed outside the platinum tube to form a fused cast refractory layer. In this Example, the fused cast refractory layer 11 is constituted by only fused cast refractories containing 1 mass % of matrix glass phase, and the component ratio of fused cast refractories containing at most 10 mass % of matrix glass phase is 100 vol %.

(2) Refractory bricks 12a: Fired bricks

As the fired bricks, zirconia type bricks (ZR, manufactured by Asahi Glass Company, Limited) are disposed outside the fused cast refractories 11a, and clay type bricks (TB, manufactured by Asahi Glass Company, Limited) are disposed outside the zirconia type bricks, and high alumina bricks (SP-13 and SP-14, manufactured by Hinomaru Ceramics Industries K.K.) are disposed in this order.

(3) In a gap between the clay type bricks and the vacuum housing 101, Microtherm (manufactured by Microtherm Corp.) are disposed as an irregular-shaped refractory 13 to fill the gap without spacing.

Six months after start of vacuum degassing, molten glass is discharged and the states inside the uprising pipe 103 and the downfalling pipe 104 are observed through a monitor window provided on a sealing of the vacuum degassing vessel 102. As a result, no deformation of walls of the uprising pipe 103 and the downfalling pipe 104 is recognized.

### COMPARATIVE EXAMPLE

The backup structure 1 is constructed in the same manner as the Example of the present invention except that AZS type fused cast refractories (Zirconite 1711 (manufactured by Asahi Glass Company, Limited), content of matrix glass phase is 20 mass %) are employed as fused cast refractories 11a. Six months after start of vacuum degassing, molten glass is discharged and the states inside the uprising pipe 103 and the downfalling pipe 104 are observed through a monitor window provided on a sealing of the vacuum degassing vessel 102. As a result, remarkable deformation on the walls of the uprising pipe and the downfalling pipe are recognized.

From these results, in the Comparative Example in which AZS type fused cast refractories containing 20 mass % of matrix glass phase are used, it is considered that at a time of vacuum degassing, glass exudation from fused cast refractories occurs and matrix glass phase is retained in a gap between the fused cast refractories and a gap between the fused cast refractories and the uprising pipe or the downfalling pipe. Accordingly, when molten glass is discharged, the retained matrix glass phase pushes outer surfaces of the uprising pipe and the downfalling pipe inwardly to deform pipe walls.

On the other hand, in the Example of the present invention employing α,β-alumina type fused cast refractories containing 1 mass % of matrix glass phase, it is considered that no glass exudation occurs from these fused cast refractories when vacuum degassing is carried out.

### INDUSTRIAL APPLICABILITY

The backup structure of the present invention is suitable for backing up hollow tubes made of platinum or a platinum alloy or a conduit tube in a vacuum degassing apparatus of molten glass or in a glass-producing apparatus.

The entire disclosure of Japanese Patent Application No. 2005-215701 filed on Jul. 26, 2005 including specification, claims, drawings and summary is incorporated herein by reference in its entirety.

What is claimed is:

1. A backup structure for hollow tube made of platinum or platinum alloy, which is used in a high-temperature environment, which contains a fused cast refractory layer provided along an outer surface of the hollow tube made of platinum or a platinum alloy, wherein at least in a portion of the fused cast refractory layer in contact with the outer surface of the hollow tube, the component ratio of fused cast refractories containing at most 10 mass % of matrix glass phase, is at least 50 vol %.

2. The backup structure for hollow tube made of platinum or a platinum alloy according to claim 1, wherein at least in the portion of the fused cast refractory layer in contact with the outer surface of the is hollow tube, the component ratio of fused cast refractories containing at most 5 mass % of matrix glass phase, is at least 50 vol %.

3. The backup structure for hollow tube made of platinum or a platinum alloy according to claim 1, wherein in the fused cast refractory layer, the component ratio of fused cast refractories containing at most 10 mass % of matrix glass phase is at least 80 vol %.

4. The backup structure for hollow tube made of platinum or a platinum alloy according to claim 1, wherein in the fused cast refractories containing at most 10 mass % of matrix glass phase, the content of metal oxides existing as inevitable impurities is less than 2 mass %.

5. The backup structure for hollow tube made of platinum or a platinum alloy according to claim 4, wherein the inevitable impurities are Fe₂O₃, CuO, PbO and/or Bi₂O₃.

6. The backup structure for hollow tube made of platinum or a platinum alloy according to claim 1, wherein the fused cast refractories containing at most 10 mass % of matrix glass phase are alumina base fused cast refractories or high-zirconia base fused cast refractories.

7. The backup structure for hollow tube made of platinum or a platinum alloy according to claim 1, wherein a refractory heat insulating material is provided on the outside of the fused cast refractory layer.

8. The backup structure for hollow tube made of platinum or a platinum alloy according to claim 1, wherein the hollow tube made of platinum or a platinum alloy is a hollow tube made of a reinforced platinum or a reinforced platinum alloy.

9. The backup structure for hollow tube made of platinum or a platinum alloy according to claim 1, wherein a surface of each of the fused cast refractories in contact with another one of the fused cast refractories is precisely polished.

10. The backup structure for hollow tube made of platinum or a platinum alloy according to claim 1, wherein the fused cast refractory layer is disposed in a positional range where the temperature of molten glass passing through the fused cast refractory layer drops to at most its devitrification point.

11. The backup structure for hollow tube made of platinum or a platinum alloy according to claim 1, wherein flanges are provided on the outer periphery of the hollow tube so as to be arranged along a longitudinal direction of the hollow tube, and the flanges are each sandwiched between fused cast refractories.

12. The backup structure for hollow tube made of platinum or a platinum alloy according to claim 1, wherein a refractory heat insulating material is provided on the outside of the fused cast refractory layer, and the refractory heat insulating material is a refractory brick layer provided on outside of the fused cast refractory layer and an irregular-shaped refractory filling a gap between the refractory brick layer and a vacuum housing.

13. A vacuum degassing apparatus for molten glass having an uprising pipe a vacuum degassing vessel and a downfalling pipe, which has the backup structure as defined in claim 1 for backing up at least one of the uprising pipe and the downfalling pipe.

14. A glass-producing apparatus employing the backup structure as defined in claim 1 for backing up a hollow tube made of platinum or a platinum alloy used as a conduit tube for molten glass.

15. A method for vacuum-degassing molten glass by using a vacuum-degassing apparatus having an uprising pipe, a vacuum-degassing vessel and a downfalling pipe, wherein the backup structure as defined in claim 1 is used for backing up at least one of the uprising pipe and the downfalling pipe.

16. A method for vacuum-degassing molten glass using the vacuum-degassing apparatus as defined in claim 13.
